(19) United States
(12) Patent Application Publication
(10) Pub. No.: US 2026/0004192 A1
(43) Pub. Date: Jan. 1, 2026

(54) SYSTEM AND METHODS FOR COLLABORATIVE FEDERATED LEARNING

(71) Applicant: Purdue Research Foundation, West Lafayette, IN (US)

(72) Inventors: Saurabh Bagchi, West Lafayette, IN (US); Somali Chaterji, West Lafayette, IN (US); Atul Sharma, West Lafayette, IN (US)

(73) Assignee: Purdue Research Foundation, West Lafayette, IN (US)

(21) Appl. No.: 19/251,710

(22) Filed: Jun. 26, 2025

Related U.S. Application Data
(60) Provisional application No. 63/664,560, filed on Jun. 26, 2024.

(51) Int. Cl. G06N 20/00

(52) U.S. Cl. CPC G06N 20/00

(57) ABSTRACT

A system for decentralized machine learning may include a hub node in communication with a plurality of spoke nodes. The hub node may receive, from a spoke node, trained model parameters for a machine learning model. The hub node aggregate the received model parameters. The hub node may exchange the aggregated model parameters with another hub node via gossip-based communication creating updated model parameters. The hub node may transmit the updated model parameters to the spoke nodes. A spoke node may receive the updated model parameters from the hub node and model parameters from a second hub node. The spoke node may aggregate the updated model parameters with the model parameters from the second hub node. The spoke node may train the local model parameters using training data.

### CROSS REFERENCE TO RELATED APPLICATIONS

This application claims the benefit of U.S. Provisional Application No. 63/664,560 filed Jun. 26, 2024, the entirety of which applications is herein incorporated by reference.

### GOVERNMENT FUNDING

This invention was made with government support under CNS-2146449 awarded by National Science Foundation. The government has certain rights in the invention.

### TECHNICAL FIELD

This disclosure relates to machine learning and, in particular, to distributed training of machine learning models.

### BACKGROUND

Machine learning techniques such as Federated Learning (FL) and Peer-to-Peer Learning (P2PL) address the challenges of training models on decentralized data. However, FL's reliance on a central coordinator introduces privacy risks and a single point of failure, while P2PL suffers from high communication costs and difficulties in achieving consensus and maintaining integrity.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example a system for hub and spokes learning (HSL).

FIG. 2A-B illustrates an example of a hub and flow logic of the hub in communication with spokes.

FIG. 3A-B illustrates an example of a spoke and flow logic of the spoke in communication with hubs.

FIG. 4 illustrates a chart showing improvement in collaborative learning with HSL.

FIG. 5 illustrates a second example of a system for HSL.

### DETAILED DESCRIPTION

Traditional federated learning systems include a server that communicates periodically with n client nodes. The server initiates training by distributing the same model to all clients. Clients (all or a subset) train the model locally on their private data and periodically share model updates with the server, which aggregates them and returns the global model. This iterative process optimizes the global objective function

$$\frac{1}{n} {\sum }_{i}^{n} {f}_{i} ( x ) \qquad Eq . 1$$

where fᵢ represents the expectation of client i's local objective, averaged over data batches in its dataset Di, using the model x received from the server. The server ensures exact consensus among all nodes at the synchronization points by sharing the updated global model to all clients. The FedSGD algorithm optimizes FL in its most basic form, as shown in in B. McMahan et al., “Communication-Efficient Learning of Deep Networks from Decentralized Data,” Proceedings of the 20th International Conference on Artificial Intelligence and Statistics (AISTATS), PMLR, 2017, pp. 1273-1282.

Since its introduction in 2017, FL has attracted research interest in various areas, such as theoretical ML, systems, and security. The learning community has studied different learning objectives and optimizers to improve the convergence of the learning process. Computer systems studies have also proposed multiple aggregation algorithms to handle heterogeneous clients in asynchronous systems. A large portion of the literature is also devoted to the study of FL systems under defined threat models.

Peer-to-peer Learning (P2PL) is a fully decentralized system where the nodes communicate as peers without the need for a central server. This eliminates the need for a single point of trust in the system, enabling greater personal control and transparency at the nodes. As edge devices become increasingly computationally powerful, model aggregation can be delegated to the learning nodes themselves rather than being restricted to a single server.

The Decentralized-SGD (D-SGD) algorithm, described in in A. Koloskova et al., “A Unified Theory of Decentralized SGD with Changing Topology and Local Updates,” Proceedings of the 37th International Conference on Machine Learning (ICML), PMLR, 2020, pp. 5381-5393, optimizes vanilla P2PL. In each learning round, connected node pairs gossip, exchange models, and update their models to the average of the received models, including their own. Gossip averaging helps maintain approximate consensus among nodes, achieving exact consensus only when every pair of nodes is connected. However, M. Assran et al., “Stochastic Gradient Push for Distributed Deep Learning,” Proceedings of the 36th International Conference on Machine Learning (ICML), PMLR, 2019, pp. 344-353 demonstrated that exact consensus is not necessary, and nodes can collaboratively learn with differing models. To avoid chaos, consensus distance among nodes must be bounded, ensuring that local models are relatively similar and in approximate agreement on the learning trajectory. L. Kong, T. Lin, A. Koloskova, M. Jaggi, and S. Stich, Consensus control for decentralized deep learning, in Proceedings of the International Conference on Machine Learning (ICML), Proceedings of Machine Learning Research (PMLR), 2021, pp. 5686-5696 recommends controlling consensus by incorporating multiple gossip averaging steps in each communication round. This ensures that consensus remains within calculated bounds for different phases of training.

Here we first describe the fundamental reasons that enable attacks on an FL system, and then move forward to describe how it is even more difficult to maintain security in P2PL because of inexact consensus. Table 1 summarizes the features of FL and P2PL and compare them with HSL.

TABLE 1
Comparison of FL, P2PL, and HSL

| Metric | FL | P2PL | HSL |
|---|---|---|---|
| Availability | Low - Server is | High - Depends | Can be controlled |
| | the critical node | on the graph | by the number of |
| | | connectivity | hubs |
| Integrity | High - Server | Low - Depends | Medium - |
| | trusted to be | on the malicious | Depends on the |
| | honest and | node distribution | malicious node |
| | byzantine-robust | among the nodes | distribution |
| Privacy | Low - Server is | Medium - Difficult | High - Mixing |
| | capable of data | to maintain both | weights can be |
| | reconstruction | privacy and | kept private |
| | attacks | consensus | without increasing |
| | | simultaneously | dissensus |
| Consensus | High - Server | Depends - on the | Can be controlled |
| | enforces exact | mixing matrix | via the hubs |
| | consensus | | |
| | among clients | | |
| Communication | Low - Every | High - Ensuring | Can be controlled |
| cost | client | model mixing | as per the |
| | communicates | requires high | capacity |
| | with the global | graph connectivity | |
| | server only | | |

FL availability—Federated Learning (FL) systems have a critical vulnerability in that the server node represents a single point of failure in the network topology. To reduce congestion and prevent failure, servers use intelligent client selection algorithms. While necessary for system availability, this approach can negatively impact the speed of convergence.

FL integrity—The server also holds a high level of trust relative to the client nodes with clients that do not trust one another, resulting in communication solely with the server. Clients must trust the server to be both benign and capable of maintaining byzantine-robustness in the face of malicious client nodes. If a server succumbs to a poisoning attack, it could disseminate the infected model to all clients, potentially derailing the entire training process. Current research focuses on maintaining byzantine-robust model aggregation algorithms, ensuring the integrity of the global model at the server. State-of-the-art defense techniques defend against directed deviation attacks, which are the most advanced model poisoning attacks. While FL system integrity is currently considered a solved problem, the ongoing cycle of attack and defense may require increasingly robust aggregation techniques in the future.

FL privacy-Privacy risks arise when clients train the server-provided model on their local data, as a curious server could attempt to reconstruct a client's local data, breaching privacy. Such attacks are possible when an entity, like the server, has knowledge of a client's initial and final model states during local training. In the case of FL, this is directly accessible to the server since the initial model is sent by the server and the update is also sent back to the server. Optimization-based data reconstruction attacks, can recover data samples during the FedSGD process, while analytic data reconstruction attacks can work in the FedAvg setting and under secure aggregation. Adding random noise can help obscure reconstruction but degrades utility. Homomorphic encryption techniques can also enhance privacy but are limited to mean aggregation, which is not byzantine-resilient.

The root cause of privacy attacks is the high level of trust enjoyed by the server, which affords it sufficient power to potentially extract privacy-sensitive information from clients. P2PL provides an opportunity to remove this level of trust from a single node and distribute it among multiple neighboring nodes, provided that neighbors do not collectively collude maliciously.

P2PL availability—P2PL systems inherently lack a central server, eliminating a single point of failure. While the graph formed by collaborating nodes may have critical edges, P2PL generally offers higher availability than FL at the cost of transferring the aggregation responsibility to participating nodes, which communicate directly with each other.

P2PL integrity—In P2PL, maintaining the integrity of the local models is each node's responsibility. Nodes can opt to use byzantine-robust aggregations from the FL domain, but extending such aggregations to P2PL is nontrivial and has not yet been explored in the literature. Some FL algorithms preserve byzantine-robustness by assuming an upper bound on the fraction fmax of potentially malicious or compromised client nodes, beyond which no guarantees can be made for model integrity. However, in the P2P setting, the distribution of malicious nodes does not need to be uniform. Given a non-uniform distribution of malicious nodes, conservatively setting fmax higher than the actual fraction of malicious nodes in the entire collaborating population may still leave some nodes unable to maintain byzantine-robustness due to a higher concentration of malicious nodes in their neighborhood. This problem is more easily addressed in FL, where the server communicates with all other nodes. In P2PL, collaborating nodes, limited by the number of connections they can have, must cope with a variable fraction of malicious nodes in each neighborhood. Other FL algorithms solve the integrity problem by computing some anomaly statistic for the nodes and detecting variable number of malicious nodes based on certain rules. However, controlling consensus in such systems is challenging. However, these algorithms can be overly conservative, leading to high false positive malicious detection rates, reduced mixing, and increased dissensus among nodes, which eventually classify an increasing number of non-consensus nodes as malicious.

Freedom vs control in P2PL—When a node cannot trust any neighboring nodes, it requires freedom of choice in assigning mixing weights. Such freedom requires relaxation of at least the doubly stochastic constraint on the mixing matrix W, which makes mathematical analysis complex. Unrestricted freedom in selecting mixing weights can result in a W that exacerbates dissensus and potentially leads to chaos. Maintaining byzantine-robustness becomes even more difficult when each node demands the freedom to choose weights. Further research in P2PL is needed to identify the permissible properties matrix W should possess for the system to be byzantine-robust and for benign nodes to achieve approximate consensus. To summarize, maintaining consensus and byzantine-robustness simultaneously in P2PL is difficult due to the absence of a controlling structure. We use this argument to motivate a two-layered HSL structure discussed later in the paper.

P2PL privacy—P2PL offers a means to maintain local data privacy at the nodes. Each node iteratively trains the locally aggregated model on its data before gossiping with neighbors. By not disclosing their mixing weights, nodes can conceal their locally aggregated models after each gossiping step. Although the final state of the model after local training is still shared with neighbors, concealing the mixing weights hides the initial model state, preventing data reconstruction attacks and privacy breaches. However, this reintroduces the challenge of guaranteeing consensus when nodes have unrestricted freedom to choose their mixing weights. The extent of mixing occurring after each gossip round depends on the matrix W, specifically its spectral gap. Without oversight on consensus or on W, it cannot be ensured that the models for each node will not diverge and that they will mix well to learn the same model. It is evident that diverging models are negatively affected by collaboration unless sufficient mixing happens. Thus, we understand that ensuring consensus is an important aspect for maintaining both byzantine-robustness and privacy in any form of collaborative learning. Bearing these considerations in mind, we propose a promising direction to address some of these challenges.

We have now seen that FL and P2PL are two forms of collaborative learning, each with its own limitations. In FL, a powerful server enforces exact consensus and Byzantine-robustness. However, this same authority also heightens the risk of breaching client privacy. On the other hand, the completely decentralized network topology in P2PL makes maintaining integrity and privacy challenging due to the non-zero consensus distance among peer nodes.

These and other challenges are overcome by the system and methods described herein which employ a hybrid Hubs-and-Spokes-Learning (HSL).

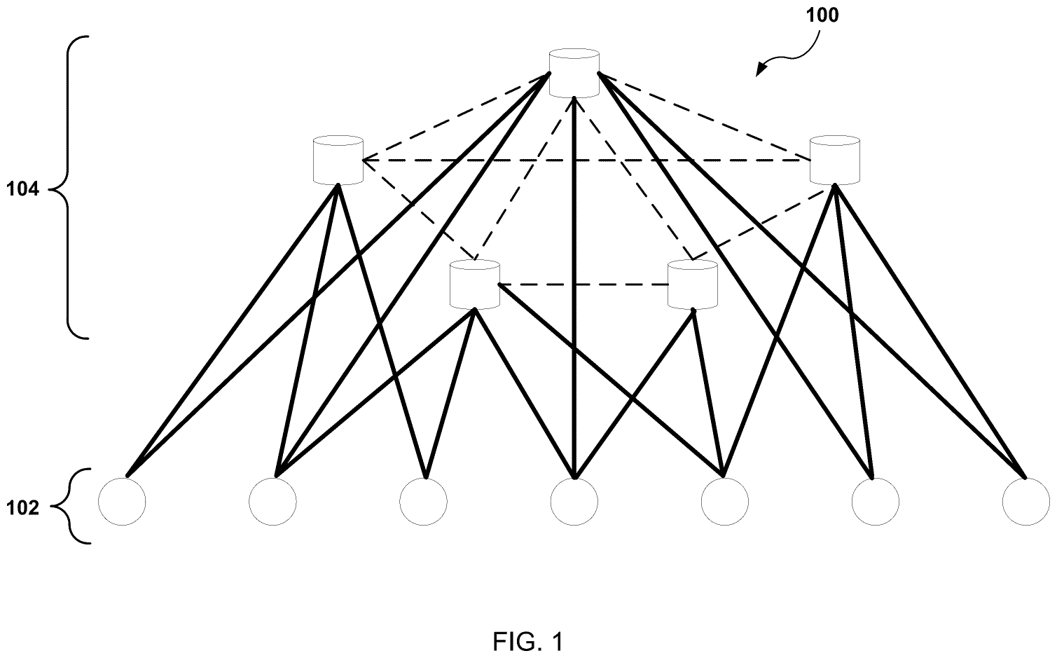

FIG. 1 illustrates an example of a system 100 for HSL. The system 100 may include spoke nodes (or spokes) 102 and hub nodes (or hubs) 104. The spoke nodes 102 may also be referred to as a spoke layer and the hub nodes 104 may be referred to as a hub layer. Each of the spoke nodes 102 may communicate with at least two hub nodes 104. Each of the hub nodes 104 may communicate with one or more other hub nodes and engage in gossip for model training. It should be appreciated that not every hub node is in communication all other hubs. For example, Hub A may communicate with Hub B and Hub C while Hub B may only communicate with Hub C. In addition, spokes do not directly communicate with one another.

Since the hubs are decentralized and there is no central node that aggregates all the hub models, the hub models exchange models with each other. This process is called gossiping. Then every hub aggregates the models that it received from other hubs via gossiping. This aggregation could be simple or byzantine robust. These aggregated models are shared back to the spokes, and after the spokes share back the updated local models to the hubs—the hubs aggregate those models and gossip again. This goes on in a loop.

Hubs receive locally trained models from the spokes, engage in gossip for model mixing, and transmit aggregated models to connected spokes. The spoke nodes may perform local model training using private data. The local model training means that the training occurs by the spoke nodes. The model are stored in the spoke nodes and/or accessed by the spoke nodes for training. The hub nodes do not directly train the models accessed by the spoke nodes. The data used by a spoke nodes for training purposes may be private to the spoke node and not shared with the hub node(s) and/or any other entity.

Accordingly, a many-to-many connection exists between the hub layer and the spoke layer. Each spoke receives models from its parent hubs (with a recommended minimum of two) and locally aggregates them using private mixing weights. This approach prevents a single hub from dictating its model to a child spoke, which is often the root cause of data leakage attacks. By keeping mixing weights private, spokes can hide their model's initial state and share the final state after local training without any privacy concerns. It may be assumed, in some examples, that the hubs are not fully connected, because an exact consensus among hubs will result in identical models at all hubs, irrespective of the mixing weights used by spokes.

While a fully connected hub graph may result in better mixing, it is not desirable if there are communication or privacy constraints. Accordingly, a technical advantage of the system and methods described herein is an allowance for inexact consensus assuming a privacy-sensitive use-case as denser connections could lead to identical or near-identical models, making privacy attacks (data reconstruction) stronger on the spokes. That is, if hub models are identical, regardless of the mixing weights the spokes use, their aggregated models will also be identical leading to data leakage attacks. When the hubs are not fully connected, partial averaging leads to a diverse set of hub models, which when aggregated by the spokes using their private mixing weights, are even more difficult to estimate.

Hubs, similar to FL servers, do not perform local training, but are responsible for Byzantine-robust aggregation of models received from spokes. Hubs primarily act as a conduit for spokes to exchange information effectively. After aggregation, hubs gossip among themselves to reach approximate consensus.

Consensus control—The collaborative HSL architecture can be viewed as multiple, interconnected FL systems, where the number of hubs can be orders of magnitude smaller than the number of spokes. The fundamental concept used in our design is that consensus among spokes can be controlled through consensus among hubs. As every spoke's model is a weighted mean of hub models, consensus among hubs bounds the consensus among spokes without imposing constraints on the spokes' mixing weights. Achieving consensus through repeated gossiping among a smaller population of nodes (hubs) compared to a larger one (spokes) also significantly lowers computation and communication costs.

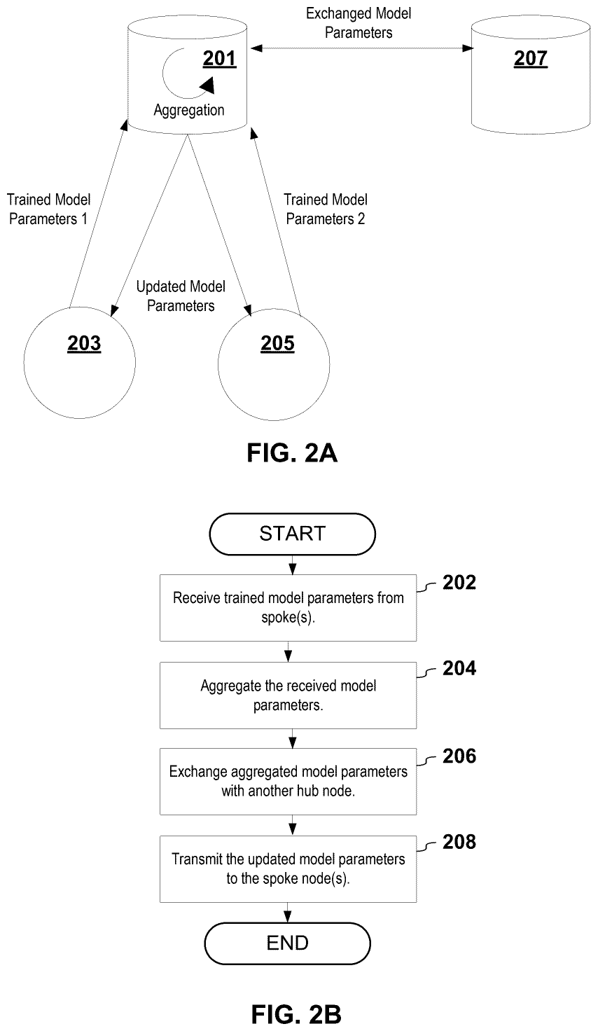

FIG. 2A-B illustrates a diagram and flow logic of a hub 201 in communication with spokes 203,205. The hub 201 may receive trained model parameters from spokes 203,205 (202). For example, the hub 201 may receive a first set of trained model parameters from a first spoke 203, and a second set of trained model parameters from a second spoke 205. It should be appreciated that the hub 201 may be in communication with additional spokes. It should also be appreciated that each set of trained model parameters received from the spokes may be different because the training data used and the manner of training may be different for each of the spokes.

The hub 201 may aggregate the received model parameters from the spokes 203,205 (204). The hub 201 may aggregate the received model parameters by performing a byzantine-robust aggregation algorithm. A byzantine-robust aggregation algorithm is one that is unaffected by the presence of malicious actors lower than its tolerable limit. Common examples include a trimmed-mean aggregation and a parameter-wise aggregation, though others are possible.

In a trimmed-mean aggregation the process is for each model parameter (e.g., weight/bias), collect the values from all m participating models. Then, sort the values. Then, trim the c largest and c smallest values (assumes 2c<m). Then, average the remaining m−2c values. The robustness provided by this technique is that tolerance is provided for up to c malicious clients. This approach balances robustness with efficiencies and is less sensitive to outliers than a straight mean.

In a median aggregation (aka coordinate-wise median), the process is for each parameter, compute the median of the m values (no trimming required). The robustness provided by this technique is that tolerance is provided for up to (m−1)/2 Byzantine workers per parameter. This approach is extremely robust in that it is resistant to arbitrarily large malicious values. This approach is also simpler than trimmed mean but less statistically efficient.

The hub node 201 may exchange the aggregated model parameters with another hub node 207 (206). The hub nodes 201,207 may engage in gossip-based communication. The gossip-based communication my follow a gossip protocol.

The gossip protocol is the manner in which a decentralized set of nodes exchange information. Each node maintains a set of its neighbors. In every round, it sends and receives models only from its current set of neighbors and aggregates the received models. In contrast, a federated protocol would collect all the models centrally and then aggregate them into a single global model.

Mixing matrix W for gossip learning-A “mixing matrix” (W) may be used to help determine how much importance a node gives to each received model. The mixing weights for node i are placed in the i^{th} row of a matrix, forming the mixing matrix W. If X is a matrix where row i represents the model weights of node i, the updated model weights after a single gossip round can be represented by the matrix WX. When nodes participate in multiple gossip rounds, the mixing matrix is raised to the power of the number of rounds (g). (Two rounds of gossip would result in W(WX)=W2X.) As the number of rounds increases, the matrix becomes denser, leading to better mixing of local models. This helps nodes maintain an approximate agreement, even when they do not have the exact same model information.

Row stochasticity of W. The mixing matrix represents what weights each hub assigns to each other. Row i of this matrix is the set of mixing weights allotted by hub i to all other hubs, hence they sum to 1 and the matrix is called row stochastic.

Column stochasticity of W-If in addition, one could enforce that the sum of all weights allotted by all hubs to every hub j is also 1, then the matrix would be column stochastic. The sum of column j in the mixing matrix W represents node j's contribution in a single gossip round, based on the weights assigned to j's model by all nodes.

Doubly Stochasticity of W. Recent works recommend constraining W to be doubly stochastic. This means that both the row and column sums of matrix W should equal 1, ensuring fairness and balance in the gossip learning process. By requiring both row and column sums to equal 1, the doubly stochastic constraint guarantees that: Each node's updated model is an equal combination of the received models, ensuring that no single model dominates the learning process. Each node's contribution to the system is equal, preventing any node from disproportionately influencing the overall learning process. Further, this constraint of column stochasticity makes it simpler to mathematically analyze the complex learning process in a decentralized setting, even when the network topologies are changing. Specifically, a doubly stochastic W has the property that 1^{T}W=1^{T}, where 1 is a column vector of one with the same dimension as the number of rows in W. The operator 1^{T} is useful in analyzing sum-like functions such that the average model weights after gossiping can be expressed as (1/n)1^{T}WX=(1/n)1^{T}X. If W is column stochastic, the operator eliminates W.

Although column stochasticity is useful in analyzing convergence in simplified cases, it is not a necessary condition for a P2PL system's convergence, as evident from practical experiments. This is significant because imposing column stochasticity means constraining the contribution of every node to be equal, which would involve artificially increasing the contribution of less popular nodes and limiting that of more popular nodes. In a malicious setting or a non-IID setting, it is not advisable to require equal contributions from all nodes, as this may not be the most optimal approach.

Alternatively or in addition, the hub nodes 201, 207 may reach consensus. For example, the system may ensure ensures approximate consensus among spoke nodes based on a consensus constraint enforced among hub nodes. If there is a strong consensus constraint among the hubs, then the hubs may perform multiple gossip steps in each round. Every gossip step involves sending and receiving local models to the connected neighbors. Since a gossip step only leads to partial averaging (full averaging only when all nodes are inter-connected), multiple gossip steps lead to stronger consensus among the hubs.

The hub node may transmit the updated model parameters to the spoke nodes 203, 205 (208). The spoke nodes may receive model parameters from other hub nodes and privately aggregate the models then perform additional training using private data.

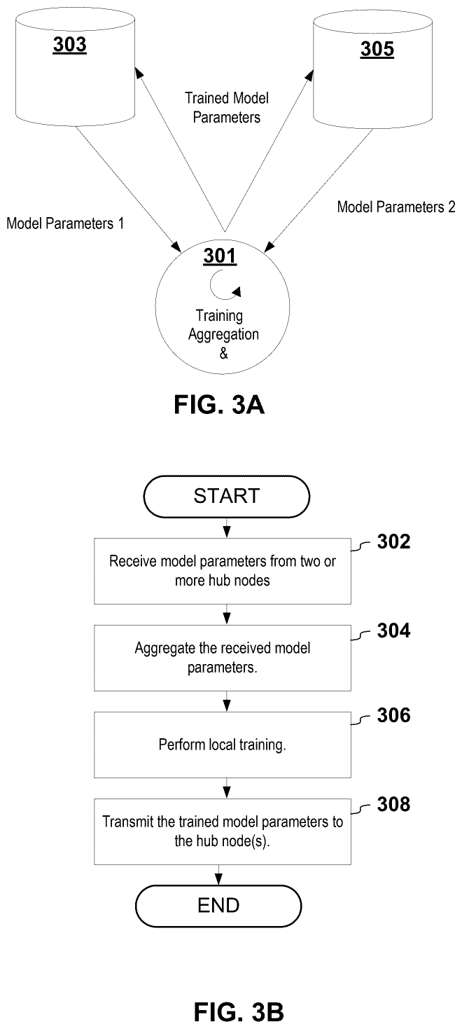

FIG. 3A-B illustrates a diagram and flow logic of a spoke 301 in communication with hubs 303,305. The spoke may receive model parameters from the hubs 303,305 (302). The spoke 301 may aggregate the receive model parameters (304). In some examples, the spoke may assign private mixing weights to each of the hubs. The private mixing weights may include, for example, coefficients used to aggregate the models parameters from each of the hubs, respectively. The mixing weights may be private. This means that the hubs and other spokes may not have access to the mixing weights. Alternatively or in addition, the mixing weights may be secret, encrypted, and/or only accessible by the spoke 301, or a user with privileged access to the spoke 301.

The spoke 301 may perform local model training using a machine learning model with the aggregate model parameters (306). The training may be performed using training data. The training data may be private to the spoke 301. This means that the hubs and other spokes may not have access to the training date. Alternatively or in addition, the training data may be secret, encrypted, and/or only accessible by the spoke 301 or a user with privileged access to the spoke 301 and/or training data.

After training is completed, the spoke 301 may transmit the trained model parameters to the hub node (308). The hub mode may proceed to perform aggregation and consensus/gossiping as described herein.

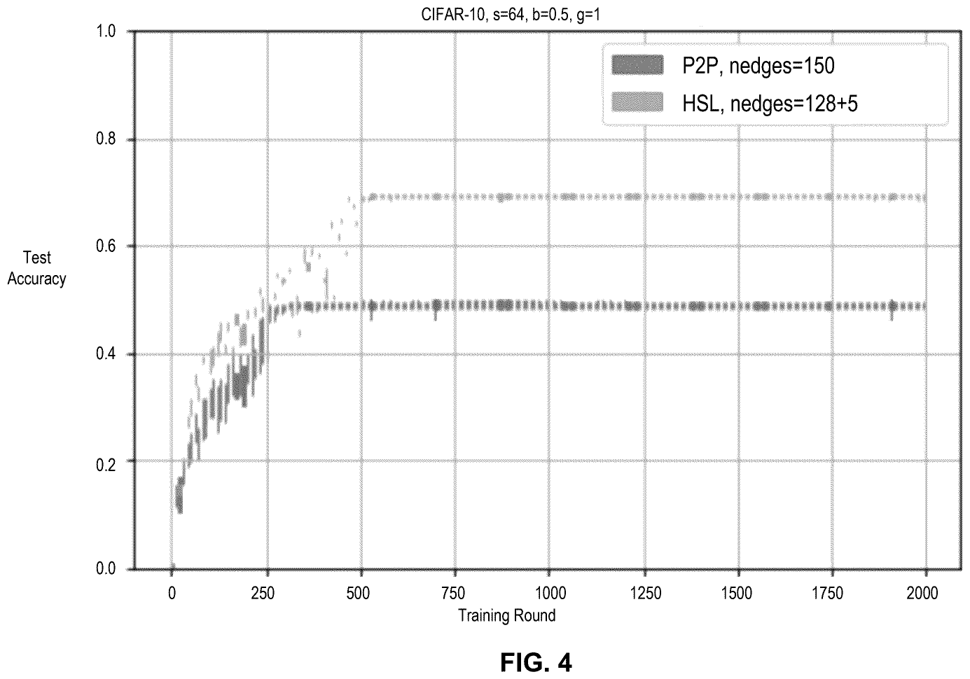

FIG. 4 illustrates a chart showing improvement in collaborative learning with HSL. The underlying experimental validation used 64 spokes and 5 hubs, with 5 edges among hubs and 128 edges between spokes and hubs (satisfying 2 hubs per spoke) The chart shows comparisons to a P2PL system with 150 randomly sampled edges. The improvement, observed with a 0.5 non-IID bias and 1 gossip step per round on CIFAR-10, is attributable to better consensus control in HSL.

Availability and communication cost—It is important to note that HSL with a single hub is functionally equivalent to FL, while HSL with n spokes and n hubs with one-to-one connections functionally represents P2PL. HSL serves as a more generalized framework that encompasses FL and P2PL. By adjusting the number of hubs, HSL can be configured to meet specific availability and communication cost objectives, given finite individual budgets.

Integrity in HSL-HSL incorporates three levels of Byzantine-robust aggregation. Although hubs may become compromised if malicious spokes are concentrated in certain neighborhoods, we propose a gossip mechanism that allows hubs to provide feedback to each other. This mechanism enables hubs to increment their fmax if they suspect a higher number of malicious spokes. Failure to act on the feedback could result in a hub being identified as malicious by its peer hubs. In addition, the spokes have access to their own model as a benign ground truth for robust aggregation. Since consensus among hubs ensures consensus among spokes, the system is less likely to spiral into chaos, unlike a P2PL system.

Accordingly, the hubs may maintain a mixing matrix whereby trust coefficients are assigned to the hub nodes. Model parameters by the hub node that are received from other hub nodes may be aggregated by a mean, a weighted mean, or by a byzantine-robust aggregation algorithm.

The system may be implemented in many ways. The hub(s) and spokes(s) of the system may be distributed and communicate over a network, in memory, or any other manner of distributed communication. The hubs and spokes may be implemented on physical or virtual hardware.

The logic illustrated in the flow diagrams may include additional, different, or fewer operations than illustrated. The operations illustrated may be performed in an order different than illustrated. The system 100 may be implemented with additional, different, or fewer components than illustrated. Each component may include additional, different, or fewer components.

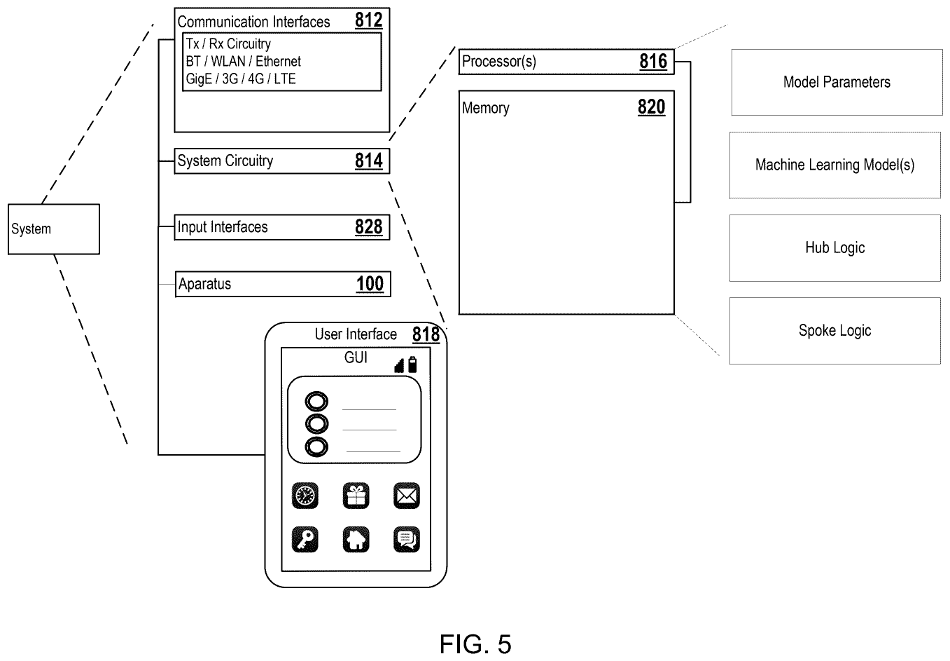

FIG. 5 illustrates a second example of the system 100. The system 100 may include communication interfaces 812, input interfaces 828 and/or system circuitry 814. The system circuitry 814 may include a processor 816 or multiple processors. Alternatively or in addition, the system circuitry 814 may include memory 820. The hardware shown in FIG. 5 may be physical hardware or virtual hardware. As described below, it may be hardware of a hub, spoke, or a combination thereof. A Hub may include hub logic whereas a spoke may include spoke logic. The hub logic may include the operations described herein which are performed by a hub. The spoke logic may include the operations described herein which are performed by a spoke.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations of the hub logic, the spoke logic, machine learning model, the system, or any other logic described herein. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the hub logic, the spoke logic, machine learning model, model parameters, mixing matrices, and/or any other logic or data described herein. Alternatively or in addition, the memory may include any other component or sub-component of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in different ways. In some examples, the system 100 may be implemented with one or more logical components. For example, the logical components of the system 100 may be hardware or a combination of hardware and software. The logical components may include the hub logic, the spoke logic, machine learning model, model parameters, mixing matrices, and/or any other logic or data described herein. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

1. A system for decentralized machine learning, comprising:
A hub node in communication with a plurality of spoke nodes, the hub node is configured to:
receive, from the spoke node, trained model parameters for a machine learning model;
aggregate the received model parameters;
exchange the aggregated model parameters with other hub nodes via gossip-based communication creating updated model parameters; and
transmit the updated model parameters to the spoke nodes,
wherein at least one of the spoke nodes are configured to:
receive the updated model parameters from the hub node and model parameters from a second hub node;
aggregate the updated model parameters with the model parameters from the second hub node; and
train the local model parameters using training data.

2. The system of claim 1, wherein aggregation of the received model parameters is byzantine robust.

3. The system of claim 1, wherein to aggregate the updated model parameters with the model parameters from the second hub node, the least one of the spoke nodes is further configured to:
access a mixing matrix comprising weight coefficients assigned to the hub node and second hub node.

4. The system of claim 3, wherein the mixing matrix is a private, wherein the spoke nodes conceal private mixing weights from the hub nodes.

5. The system of claim 1, wherein the gossip-based communication among the hub nodes includes application of a row stochastic mixing matrix.

6. The system of claim 1, wherein the gossip-based communication among the hub nodes includes application of a doubly stochastic mixing matrix.

7. The system of claim 1, wherein the number of hub nodes is less than the number of spoke nodes by at least an order of magnitude.

8. The system of claim 1, wherein the system ensures approximate consensus among spoke nodes based on a consensus constraint enforced among hub nodes.

9. A method for decentralized machine learning, comprising:
receiving, by a hub node, trained model parameters for a machine learning model provided by a spoke node;
aggregating, by the hub node, the received model parameters;
exchanging, by the hub node, the aggregated model parameters with model parameters from other hub nodes via gossip-based communication creating updated model parameters;
transmitting, by the hub node, the updated model parameters to the spoke node;
receiving, by the spoke node, the updated model parameters from the hub node;
aggregating, by the spoke node, the updated model parameters with model parameters from a second hub node; and
training, by the spoke node, the local model parameters using training data.

10. The method of claim 9, wherein the aggregation of the received model parameters is byzantine robust.

11. The method of claim 9, wherein aggregating, by the spoke node, the updated model parameters with model parameters from a second hub node further comprising:
accessing a mixing matrix comprising weight coefficients respectively assigned to the hub node and second hub node.

12. The method of claim 11, wherein the mixing matrix is a private, wherein the spoke node conceals private mixing weights from the hub node.

13. The method of claim 9, wherein exchanging, by the hub node, the aggregated model parameters with model parameters from other hub nodes via gossip-based communication further comprises:
receiving model parameters from the other hub nodes; and
aggregating the model parameters from the other hub nodes.

14. The method of claim 13, wherein aggregating the model parameters from the other hub nodes comprises accessing a mixing matrix with weights respectively assigned to the other nodes.

15. The method of claim 14, wherein the mixing matrix is row stochastic.

16. The method of claim 15, wherein the mixing matrix is doubly stochastic.
